(19) United States
(12) Patent Application Publication
(10) Pub. No.: US 2026/0346207 A1
(43) Pub. Date: Nov. 5, 2026

(54) METHOD FOR CLEANING A FILTER

(71) Applicant: FRESENIUS MEDICAL CARE DEUTSCHLAND GMBH, Bad Homburg (DE)

(72) Inventors: Gerhard WIESEN, Bad Homburg (DE); Sebastian-Johannes ARMBRUST, Bad Homburg (DE); Wolfgang WEHMEYER, Bad Homburg (DE)

(73) Assignee: FRESENIUS MEDICAL CARE DEUTSCHLAND GMBH, Bad Homburg (DE)

(21) Appl. No.: 19/488,111

(22) PCT Filed: Jun. 3, 2024
(86) PCT No.: PCT/EP2024/065226

§ 371 Date: Nov. 26, 2025

(30) Foreign Application Priority Data
Jun. 2, 2023 (DE) 10 2023 114 632.7

(51) Int. Cl. B01D 65/02; B01D 61/14; B01D 63/02; B01D 65/10

(52) U.S. Cl. CPC B01D 65/02; B01D 61/145; B01D 63/02; B01D 65/10; B01D 2321/02; B01D 2321/04; B01D 2321/18

(57) ABSTRACT

The method for cleaning filters (10) with a filter housing (11), wherein the filter (10) has two opposite inlet connections (12a, 12b), at least one outlet connection (14a) and at least one membrane (24), wherein the outlet connection (14a) is separated from the inlet connections (12a, 12b) by the at least one membrane (24) and wherein the membrane (24) has a lumen (25) connecting the two inlet connections (12a, 12b) to one another, which has an inner diameter of 180-600 μm and a length of 50 to 200 cm, comprises the following steps:
blocking the outlet connection (14a);
introducing fluid, in particular untreated fluid, into a first inlet connection (12a);
opening the second inlet connection (12b) for discharging the fluid.

### FIELD OF THE INVENTION

The invention relates to a method for backwashing and cleaning filters, in particular industrial filters.

### PRIOR ART

Water filtration ultrafilters must be washed out regularly to restore filtration capacity. For this purpose, the filter is usually subjected to backwashing, in which the water is introduced on the clean side of the filter and passed through the filter to the untreated water side, so that the filtered particles are washed out of the filter. The water used for this backwashing process must therefore be free of contaminants to avoid contaminating the clean side of the filter. This contaminant-free backwashing water typically comes from a separate container or a second ultrafilter running in parallel with the first ultrafilter. In backwash mode, the untreated water is filtered by the second ultrafilter and then sent to the outlet of the ultrafilter to be cleaned. From there, this clean water flows through the membrane of the ultrafilter to be cleaned to the feed side, flushing particles out of the membrane and into a drain via the feed side inlet. After this ultrafilter has been cleaned, the process can be reversed and the second ultrafilter cleaned with the first ultrafilter. A two-filter system of this kind is an endless source of clean water for backwashing. Furthermore, the flow of liquid through the membrane structure flushes away the particles from the pores of the membrane.

However, this procedure always requires at least two ultrafilters that can be connected to one another, or a container that can be connected to the ultrafilter and is filled with filtered water. A two-filter system is therefore significantly expensive and there is a high resistance for the backwash water to reach the core of the membrane bundle. This can lead to an unbalanced cleaning of the fibers. In addition, it is possible that parts of the membrane bundle can be damaged more easily due to the high pressure to be applied.

### Presentation of the Invention

The object of the invention is therefore to provide a method with which an ultrafilter can be cleaned in a simple manner without the aid of another filter or a container filled with filtered water and with which, in particular, a high degree of uniformity of cleaning is achieved right down to the core of the membrane bundle.

This object is achieved by a method according to claim 1. Further features embodying the invention are contained in the dependent claims.

The method according to the invention for backwashing and cleaning filters with a filter housing, wherein the filter has two opposite inlet connections, at least one outlet connection and at least one membrane, wherein the outlet connection is separated from the inlet connections by the at least one membrane and wherein the membrane has a in particular a cylindrical lumen connecting the two inlet connections with one another, which have an inner diameter of 180-600 μm, in particular at least 200 μm, in particular 230, up to a maximum of 400 μm or 300 μm, and a length of at least 50 cm, preferably 70 cm or 100 cm, and at most 200 cm, in particular 150 cm or 120 cm, comprising the steps of blocking the outlet connection, introducing fluid, in particular untreated fluid, into a first inlet connection and opening the second inlet connection to discharge the fluid. The blocking of the outlet connections and the design of the membrane make it possible for the membrane to filter the water with which it is cleaned first in the region of the flow inlet. This filtrate is then fed back into the lumen of the membrane in the region of the flow outlet by backwashing, which constitutes the cleaning process. This provides an easy way to clean a single ultrafilter without the need for additional filters or ancillary equipment that provides purified water. Thus the ultrafilter backwash for a single filter allows the construction of systems with minimal hydraulic complexity. This method is very cost-effective and able to produce clean water between two backwash processes. Furthermore, a two-filter system allows non-stop continuous flow and can even be operated intermittently if an ultra-filter is defective. In addition, a defective filter has no effect on the intact filter and does not contaminate the clean side with biomaterial or other dirt.

In one embodiment, after the fluid has been discharged, the second inlet connection is used for introducing the fluid and the fluid is discharged through the first inlet connection. This ensures that both end regions of the membrane and also the entire length are flushed and cleaned particularly evenly.

Furthermore, the inlet connections are preferably arranged one above the other, in particular aligned with one another and preferably arranged coaxially, and backwashing preferably takes place first from bottom to top and then vice versa. This allows gravity to increase the pressure difference of the cleaning fluid during the second backwashing, making cleaning more effective.

The introduction of fluid is preferably stopped after backwashing and air or gas is introduced through an inlet connection and/or the outlet connection for gas flushing. As a result, the cleaning liquid and also contamination residues that were not removed during backwashing, for example from the pores, are reliably removed, which is ensured in particular by introducing gas through the outlet connection. The introduction of the gas through the inlet connection is advantageous when contaminant constituents trapped on the inner surface of the membrane lumen have to be removed by shearing. This air flushing also entails the advantage of a pressure difference of the ultrafilters being used and ensures thorough cleaning of the membrane. Furthermore, the gas may be introduced into the outlet connection and one inlet connection can be blocked and the other one can be open. In this way, certain parts of the membrane can additionally be cleaned with gas in a targeted manner. In a further embodiment, air can be simultaneously introduced into the outlet connection through the upper or lower inlet connection while the other inlet connection serves as a drain. This ensures that the central region in the longitudinal extension of the membrane bundle in particular is additionally subjected to a particularly thorough cleaning.

As a further step, one inlet connection can be opened to the environment and the other inlet connection, in particular the lower inlet connection, can serve as a drain. This will remove all fluid from the filter and complete the cleaning process so that the filtration process can start again. In addition, air can be reintroduced into the outlet connection during the emptying process in order to support the emptying process and remove any remaining contaminants.

An integrity test can preferably be carried out during the method, in particular after the first air flushing, in order to test the function of the filter and to ensure that the filter is ready for optimal operation.

### BRIEF DESCRIPTION OF THE FIGURES

FIG. 1 shows a schematic representation of a filter for the method according to the invention;

FIG. 2 shows a magnified view, not to scale, of a fiber with a membrane;

FIGS. 3a-f show different stages of the method according to the invention.

### DESCRIPTION OF THE PREFERRED EMBODIMENTS

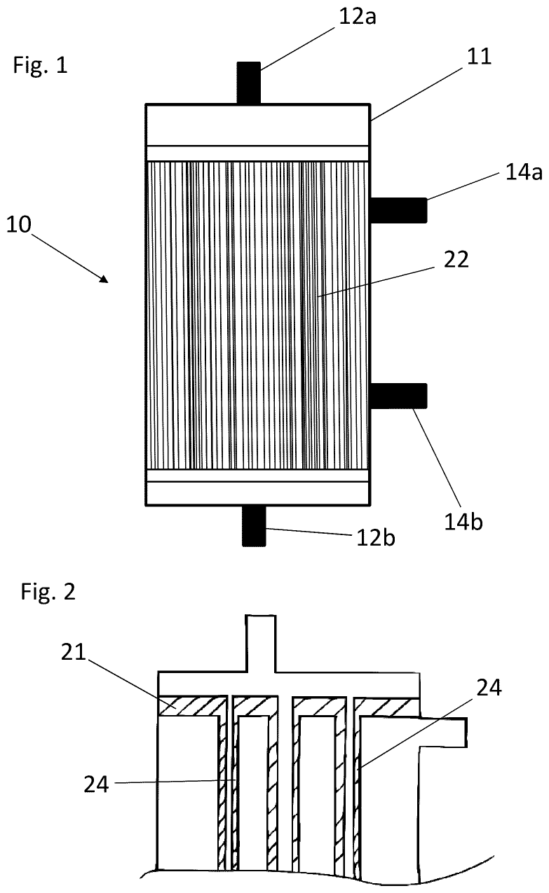

FIG. 1 shows a schematic representation of a filter 10 with which the method according to the invention can be carried out. This filter 10 has a filter housing 11 with at least two inlet connections 12a, 12b into which untreated water is introduced during normal operation. This untreated water then flows through the filter device 20 to at least one outlet connection 14a. However, two or more outlet connections 14a, 14b are preferably provided. The inlet connections 12a, 12b are arranged one above the other and in particular on opposite sides or concentrically.

The filter device 20 has a plurality of fibers 22 which each comprise a membrane 24. The fibers 22 extend along the longitudinal axis of the filter and are clamped at the upper and lower end in a holding device 21 which fastens the fibers in the filter 10. The holding device is designed to be porous, so that the untreated water can flow into the membrane 24 unhindered. The membrane 24 is preferably cylindrical and encloses a lumen 25 (cavity) which extends between the inlet connections 12a, 12b and connects the inlet connections 12a, 12b to one another.

FIG. 2 shows a magnification of the membrane 24 and the lumen 25, which is not to scale. The lumen 25 has an internal diameter of 180 to 600 μm or the minimum and maximum dimensions previously mentioned. The very narrow diameter of the lumen compared to conventional fibers ensures that the untreated water that flows into the filter through the inlet connections is slowed down in this lumen. This is important for the method explained below and leads to the unexpected effect that allows backwashing with a single filter. Diameter The length of the lumen, namely the longitudinal extent, is between 50 and 200 cm, in particular between 70 and 150 cm, more particularly between 70 and 120 cm.

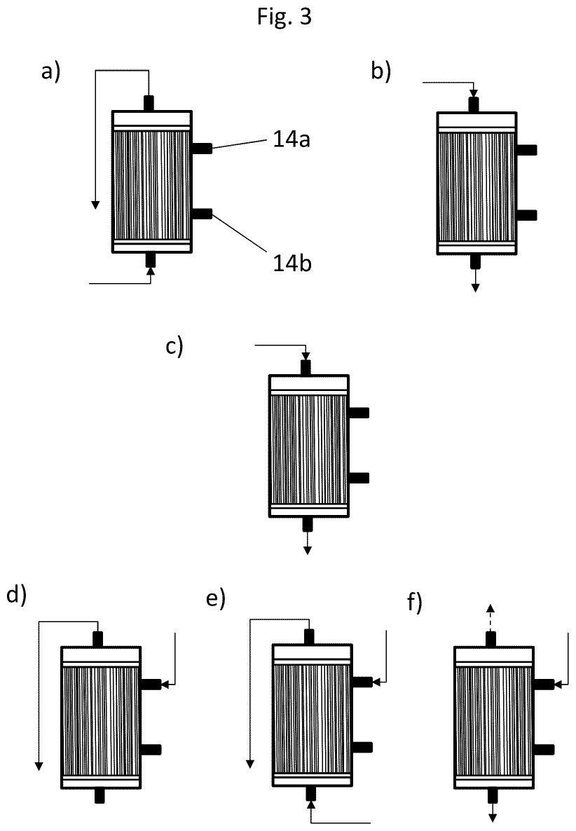

In normal operation, untreated water flows into the inlet connections 12a, 12b. From there it enters the lumen of the fibers via the pores in the holding device 21 and is filtered on the filtrate side as it passes through the membrane 24 and then conveyed out of the outlet connections 14a, 14b. Various steps of the method are shown in FIGS. 3a to 3f, wherein the filter is shown only schematically. FIG. 3a shows the first step, in which the outlet connections 14a, 14b are blocked, so that no more filtered water can escape from there. Untreated water is then filled into the filter 10 through an inlet connection, in this case the lower connection 12b. As a result, the filtrate side is filled with filtered water, which, however, cannot flow out. The flow resistance in the longitudinal direction in the lumen 25 causes a pressure drop. In FIG. 3a, the pressure on the upper side of the lumen 25 (namely on the side of the inlet connection 12a) is lower than on the lower side, on which the untreated water is pumped into the filter 10. In addition, the water pushes below onto the filtrate side of the membrane 24, so that on the upper side the filtered water has to flow through the membrane back to the untreated water side, thus removing the contaminants in the pores of the membrane and cleaning it. The fiber bundle is therefore only cleaned by longitudinal shearing forces and reduced flow. In principle, the filter device 20 can be at least partially cleaned with this procedure.

FIG. 3b shows the preferred step, in which the direction of flow is then reversed. By reversing the flow direction, the opposite part (here the lower one) of the fiber bundle is cleaned in the same way by back-filtration. Since the water penetrates all fibers in parallel, the same flow conditions prevail on the inner fibers of the fiber bundle as on the outer fibers, so that essentially all fibers are cleaned evenly. While the top and bottom ends of the fibers are cleaned better than at the center, reversing the backwash ensures that this effect is reduced, namely the fibers experience some backwash along the entire length of the fiber.

The preferred air cleaning is shown in FIG. 3c. Another medium such as gas or air is introduced at the connected upper inlet connection 12a. The liquid is emptied from the lumen and conveyed to the other inlet connection 12b by means of ambient pressure, gravity and/or pressurized gas or air. There, the cleaning liquid is then disposed of in a drain. The liquid/gas phase interface increases the shear stress on the inner surface of the membrane and helps transport contaminants to the drain. Also, gas cleaning occurs uniformly on the inner and outer fibers. This process can be reversed with respect to the inlet connections 12a, 12b.

Further gas cleaning options are shown in FIGS. 3d-f. In FIG. 3d, the lower inlet connection 12b is closed and air is introduced via one or more outlet connections 14a, 14b. In addition to the outlet connections, the lower inlet connection 12b can also be reconnected to a gas connection (FIG. 3e). This process can also be reversed for the inlet connections 12a, 12b.

In the case of the outlet connections, it makes no difference for the cleaning which outlet connections 14a, 14b are acted upon by gas. In case of a plurality of outlet connections 14a, 14b at the same time, however, the gas supply can be increased. In contrast, in the case of the inlet connections 12a, 12b, it makes a difference when and how the upper or lower inlet connection 12a, 12b is filled with gas or untreated water or whether it is opened to the environment or to a drain. When cleaning is performed over the top, the backwashed volume generates shear forces along the entire length in the longitudinal direction of the fiber length and transports the dirt particles out of the filter. The supply of air into the lumen from below creates turbulent phase boundaries between liquid and air, which support the cleaning effect of this upward flushing.

When the drain is open downward and the inlet connection is closed at the top, the water stagnates on the upper inlet side and stays in the filter. It may then be that the filtrate side is completely empty and the inlet side is still full. If the inlet side is also to be emptied, the corresponding inlet connection 12a, 12b must be opened to the environment.

Furthermore, an integrity test can be carried out during the backwashing process or gas cleaning in order to detect damage to the fibers and membranes.

The effective and efficient recovery of filter capacity is highly dependent on the type of contaminants in the untreated water. In principle, the method steps can also be carried out individually, but it is preferable to use the various method steps and the initial filling process in combination and/or repeatedly so that all requirements with regard to filter life, time and water consumed are met.

A possible cleaning method can be structured as follows, for example:
Step 1: flushing from bottom to top; step 2: flushing from top to bottom; step 3: air flushing; step 4: integrity test; step 5: emptying the filtrate upwards with air from below; step 6: air flushing; step 7: filter filling.

### LIST OF REFERENCE NUMERALS

10 filter
11 filter housing
12a, 12b inlet connections
14a, 14b outlet connections
20 filter device
21 holding device
22 fiber
24 membrane
25 lumen

1. A method for cleaning filters with a filter housing wherein the filter has two opposite inlet connections at least one outlet connection and at least one membrane wherein the outlet connection is separated from the inlet connections by the at least one membrane and wherein the membrane has a lumen connecting the two inlet connections to one another, which has an inner diameter of 180-600 μm and a length of 50 to 200 cm, comprising the steps:
blocking the outlet connection
introducing fluid into a first inlet connection
opening the second inlet connection for discharging the fluid.

2. The method of claim 1, wherein after the fluid has been discharged, the second inlet connection is used to introduce the fluid and the fluid is discharged through the first inlet connection.

3. The method of claim 2, wherein the inlet connections are arranged one above the other.

4. The method of claim 1, wherein the introduction of the fluid is stopped and gas is introduced through an inlet connection and/or outlet connection for gas flushing.

5. The method of claim 1, in which gas is introduced into the outlet connection and one inlet connection is blocked and one is open.

6. The method of claim 3, wherein gas is introduced simultaneously into the outlet connection through the upper or lower inlet connection while the other serves as a drain.

7. The method of claim 1, in which, as a last step, one inlet connection is opened to the environment and the other inlet connection serves as a drain.

8. The method of claim 1, wherein an integrity test is performed during the method.

9. The method of claim 2, wherein the inlet connections are arranged one above the other and the backwashing takes place first from bottom to top and then vice versa.

10. The method of claim 1, wherein the fluid is untreated fluid.
